(19) United States
(12) Patent Application Publication
(10) Pub. No.: US 2018/0290465 A1
(43) Pub. Date: Oct. 11, 2018

(54) SENSING MEDIA AND A MEDIA TRAY

(71) Applicant: HEWLETT-PACKARD DEVELOPMENT COMPANY, L.P., Houston, TX (US)

(72) Inventor: Arthur H. Barnes, Vancouver, WA (US)

(73) Assignee: HEWLETT-PACKARD DEVELOPMENT COMPANY, L.P., Houston, TX (US)

(21) Appl. No.: 15/570,952

(22) PCT Filed: Jul. 24, 2015
(86) PCT No.: PCT/US2015/041859

§ 371 Date: Oct. 31, 2017

(51) Int. Cl. B41J 11/00; B41J 15/04; B41J 13/10

(52) U.S. Cl. CPC B41J 11/0095; B41J 13/103; B41J 15/042

(57) ABSTRACT

In an example implementation, a device for sensing media and a media tray includes a sensor to transmit light toward a media tray port, and to generate current from light received at the sensor. The device also includes a circuit to convert the current into a voltage signal to be compared with a threshold for determining one of a media present condition, a media empty condition, and a media tray absent condition.

### BACKGROUND

Printers come in a wide variety of sizes, formats, and technology types. Inkjet printing technology, for example, is implemented in printers that range in size from small, consumer-based desktop printers, to large-format, commercial-based printers and plotters. Whatever the size or technology, printers consume various supplies such as ink, toner, and print media. Depending on the printing application and which printing technology is being implemented, the print media can include various types of cut-sheet and/or roll material, such as paper, card stock, transparencies, fabric, canvas, polyester, and so on. Whether a printer uses roll-fed or cut-sheet print media, or both, maintaining an adequate media supply enables a more efficient use of both the printer and the user's time. This can be especially true in scenarios where multiple users share a remote printer.

### BRIEF DESCRIPTION OF THE DRAWINGS

Examples will now be described with reference to the accompanying drawings, in which:

FIG. 1 shows in block diagram form an example of an inkjet printer suitable for implementing a sensing device for sensing media and a media tray;

FIG. 2 shows an example of an inkjet printer in a “media present condition”;

FIG. 3 shows an example of an inkjet printer in a “media tray absent condition”;

FIG. 4 shows an example of an inkjet printer in a “media empty condition”;

FIG. 5 shows an example of a sensor circuit that can distinguish between weak, medium, and strong signals received from a sensor;

FIG. 6 shows an example response of a sensor circuit to different current signal levels generated by a sensor; and

FIG. 7 shows a flow diagram that illustrates an example method for sensing media and a media tray.

Throughout the drawings, identical reference numbers designate similar, but not necessarily identical, elements.

### DETAILED DESCRIPTION

Most printers have some mechanism for determining when the media supply is low or empty. For example, in printers that use both roll-fed media and cut-sheet media from a media tray, there may be one sensor mechanism to indicate when there is a low or empty media roll condition, and another sensor mechanism to indicate when there is an empty media condition within the cut-sheet media tray. Prior sensor mechanisms used in cut-sheet media trays have included two-state sensors that discern between a “media present condition” and a “media absent condition.” However, discerning a third condition that indicates whether the media tray is absent from the printer is also desirable for users.

Options for determining a third, “media tray absent” condition, include adding another sensor to the printer. However, the added cost for an extra sensor may be prohibitive. Another option is to provide a single, three-state, sensor mechanism that is more cost-effective and is able to accurately discern between all three conditions (i.e., media present condition, media absent condition, media tray absent condition). There have been a number of challenges, however, that have prevented the production and implementation of such a three-state sensing mechanism. One challenge in detecting the three different conditions (i.e., media present, media absent, media tray absent) involves distinguishing between weak detection signals and medium detection signals that are close in value to one another. Noise voltage levels can make it difficult to discern signal strengths, and can cover up weak detection signals to the extent that the weak signals are below, or so near to, the noise floor that they cannot be distinguished from medium strength signals. One potential solution to this challenge may be to employ the use of logarithm amplifiers to perform this function. However, the use of logarithm amplifiers adds significant cost and complexity.

Accordingly, examples described herein provide a device to accurately and cost-effectively sense and determine a media present condition, a media absent condition, and a media tray absent condition. The example device employs a three-state sensor mechanism that incorporates inexpensive components to enable a robust alternative to adding another sensor or to implementing complex and costly logarithm amplifiers. The example device implements a variable gain technique that provides an inexpensive and accurate approximation to a logarithm amplifier.

In one example implementation, a device for sensing media and a media tray includes a sensor to transmit light toward a media tray port, and to generate current from light received at the sensor. The device also includes a circuit to convert the current into a voltage signal that is to be compared with a threshold for determining one of a media present condition, a media empty condition, and a media tray absent condition.

In another example implementation, a method for sensing media and a media tray includes receiving light at a photo-electric sensor and converting the received light into a current signal. The method then includes inducing a voltage with a first resistance when the current signal is within a first range, and inducing a voltage with a second resistance when the current signal is within a second and third range. The method then includes comparing the voltage with a threshold to determine one of a media present condition, a media empty condition, and a media tray absent condition.

In another example implementation, a media and media tray sensing device includes a sensor disposed on a printer, and a mirror disposed on a media tray of the printer. A light emitter in the sensor is to transmit light, and a light detector in the sensor is to receive light from at least one of, light that is reflected off the mirror, light that is reflected off media in the media tray, and ambient light. The device also includes a circuit to convert current produced by the light detector into a voltage to be used for determining one of a media present condition, a media empty condition, and a media tray absent condition.

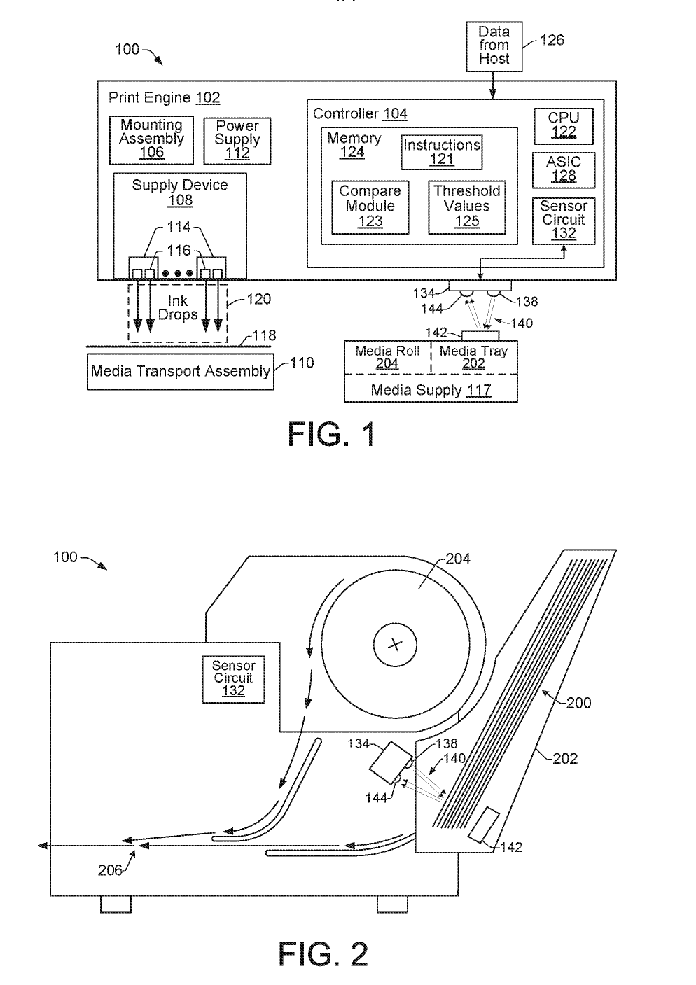

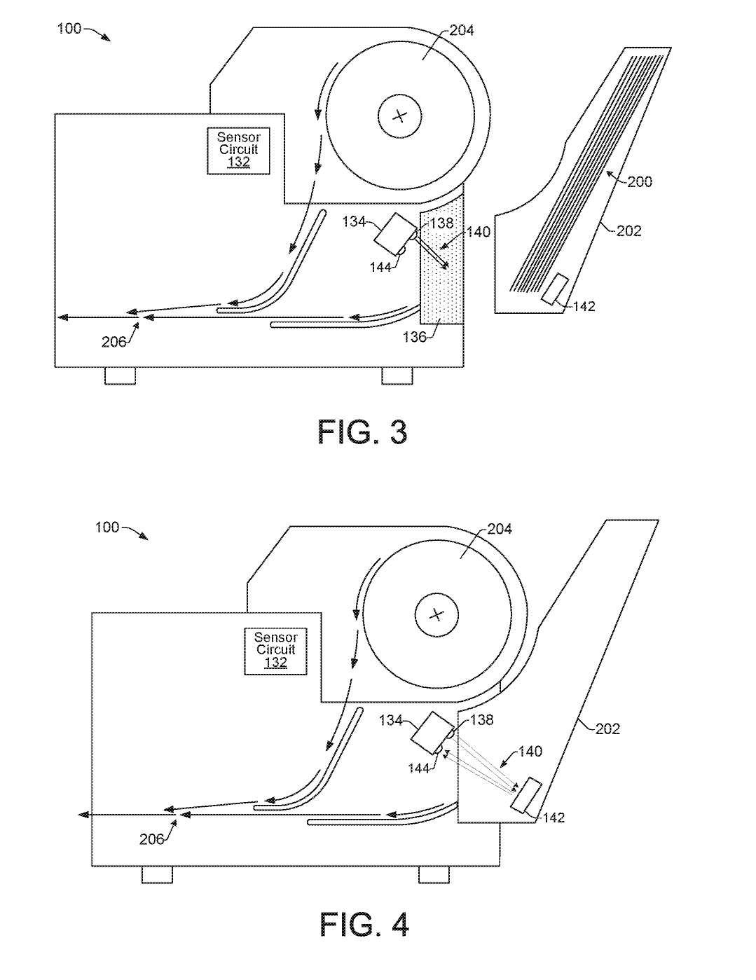

FIG. 1, FIG. 2, FIG. 3, and FIG. 4, each show an example of an inkjet printer 100 suitable for implementing a sensing device for sensing media and a media tray as described herein. FIG. 1 shows a general functional block diagram of an example inkjet printer 100, while each of FIGS. 2, 3, and 4, shows a partial side view of an example inkjet printer 100 in which FIG. 2 illustrates a “media present condition”, FIG. 3 illustrates a “media tray absent” condition, and FIG. 4 illustrates a “media empty condition”. FIGS. 2, 3, and 4, each include basic illustrations of a sensor 134 and a circuit 132, discussed below in greater detail, where the sensor 134 is to transmit light toward a media tray port and generate current from light received at the sensor, and the circuit 132 is to convert the current into a voltage signal to be compared with a threshold for determining one of a “media present condition,” a “media empty condition,” and a “media tray absent condition.” While an inkjet printer is used as an example in each figure, other printer examples are possible and contemplated, including laser jet printers and other printers that employ media trays to supply cut-sheet media to the printer. In this example, as shown in FIG. 1, the inkjet printer 100 includes a print engine 102 having a controller 104, a mounting assembly 106, replaceable fluid supply device(s) 108, a media transport assembly 110, and at least one power supply 112 that provides power to the various electrical components of inkjet printer 100.

The inkjet printer 100 also includes a printhead assembly 114 (e.g., a thermal or piezoelectric printhead assembly), to eject drops of ink or other fluid through a plurality of nozzles 116 toward print media 118 so as to print onto the media 118. Nozzles 116 can be arranged in one or more columns or arrays along a MEMS (microelectromechanical systems) die (not shown) of printhead assembly 114 such that properly sequenced ejection of ink from nozzles 116 causes characters, symbols, and/or other graphics or images to be printed on print media 118 as the printhead assembly 114 and print media 118 are moved relative to each other. In some examples, printhead assembly 114 can be an integral part of a fluid supply device 108, while in other examples printhead assembly 114 can be mounted on a print bar (not shown) of mounting assembly 106 and coupled to a supply device 108 (e.g., via a tube).

A media supply 117 coupled with or inserted into printer 100 can include different print media supplies such as a media tray 202 and a media roll 204. The print media 118 provided by a media supply 117 can include suitable cut-sheet media 200 that can be fed to the printer 100 from a media tray 202, such as paper, card stock, transparencies, fabric, canvas, polyester, and so on. As noted, the print media 118 can also include roll-fed media from a media roll 204 comprising various types of suitable printable material. As shown in FIGS. 2-4, print media 118 from a media roll 204 and cut-sheet media 200 from media tray 202 follows a media path 206 through the printer during a printing operation.

Mounting assembly 106 positions the printhead assembly 114 relative to media transport assembly 110, and media transport assembly 110 positions print media 118 relative to printhead assembly 114. Thus, a print zone 120 is defined adjacent to nozzles 116 in an area between printhead assembly 114 and print media 118. In one example, print engine 102 is a scanning type print engine. As such, mounting assembly 106 includes a carriage for moving printhead assembly 114 relative to media transport assembly 110 to scan print media 118. In another example, print engine 102 is a non-scanning type print engine. As such, mounting assembly 106 fixes printhead assembly 114 at a prescribed position relative to media transport assembly 110 while media transport assembly 110 positions print media 118 relative to printhead assembly 114.

Controller 104 includes a processor (CPU) 122, firmware and/or software such as executable instructions 121, memory components 124 including volatile and non-volatile memory components, and other printer electronics for communicating with and controlling inkjet printhead assembly 114, mounting assembly 106, media transport assembly 110, media supply 117, and other functions of printer 100. The components of memory 124 comprise non-transitory, machine-readable (e.g., computer/processor-readable) media that provide for the storage of machine-readable coded program instructions, data structures, program instruction modules, JDF (job definition format), and other data for the printing system 100, such as instructions 121, threshold comparison module 123, and threshold values 125. The program instructions, data structures, and modules stored in memory 124 may be part of an installation package that can be executed by a processor (CPU) 122 to implement various examples, such as examples discussed herein. Thus, memory 124 may be a portable medium such as a CD, DVD, or flash drive, or a memory maintained by a server from which the installation package can be downloaded and installed. In another example, the program instructions, data structures, and modules stored in memory 124 may be part of an application or applications already installed, in which case memory 124 may include integrated memory such as a hard drive.

Controller 104 receives data 126 from a host system, such as a computer, and temporarily stores data 126 in a memory 124. Data 126 can be sent to printer 100 along an electronic, infrared, optical, or other information transfer path. Data 126 represents, for example, a document and/or file to be printed. As such, data 126 forms a print job for printer 100 and includes print job commands and/or command parameters. Using data 126, controller 104 can control inkjet printhead assembly 114 for the ejection of ink drops from nozzles 116. For example, the controller 104 can define a pattern of ejected ink drops that form characters, symbols, and/or other graphics or images on print media 118. The pattern of ejected ink drops is determined by the print job commands and/or command parameters from data 126.

In some examples, the controller 104 may include a printer application specific integrated circuit (ASIC) 128. Controller 104 also includes a sensor circuit 132, which in some examples may reside within the printer ASIC 128. The sensor circuit 132 is to receive photo current signals from a sensor 134 and provide corresponding voltages that enable determinations to be made about the condition of printer media 200 and media tray 202. The threshold comparison module 123 comprises computer readable instructions executable by the CPU 122 or ASIC 128 to perform comparisons of predetermined threshold values 125 with digital voltage signals received from the sensor circuit 132. Based on these comparisons, the threshold comparison module 123 determines one of three different conditions regarding the media tray 202 and print media 200 within the media tray 202. More specifically, based on the threshold values 125 and voltage signals from sensor 134, the threshold comparison module 123 determines one of a media present condition, a media empty condition, and a media tray absent condition.

As shown in FIGS. 1-4, the sensor 134 is positioned on the printer 100. The illustration of the printer 100 in FIG. 2 shows the condition in which media is present in the media tray 202 (i.e., a “media present condition”), and the media tray 202 is inserted into, or coupled to, the printer 100. FIG. 3, however, illustrates the condition in which the media tray 202 is absent or removed from the printer 100 (i.e., a “media tray absent condition”). Thus, in FIG. 3, a media tray port 136 is viewable. The media tray port 136 is the location or slot into which the media tray 202 is to be inserted in order to enable cut-sheet media 200 to be accessed by the printer 100.

Referring generally to FIGS. 1-4, the sensor 134 comprises a light source 138, such as an LED 138 (light-emitting diode) to generate and transmit light in the form of a light beam 140, for example, toward the media tray port 136. Thus, the light 140 from the sensor 134 intersects or contacts the media tray 202 when the media tray 202 is present within the media tray port 136, as shown in FIGS. 2 and 4. Otherwise, when the media tray is absent from the media tray port 136 (i.e., a “media tray absent condition”) as shown in FIG. 3, the light 140 enters the media tray port 136 without contacting the media tray 202.

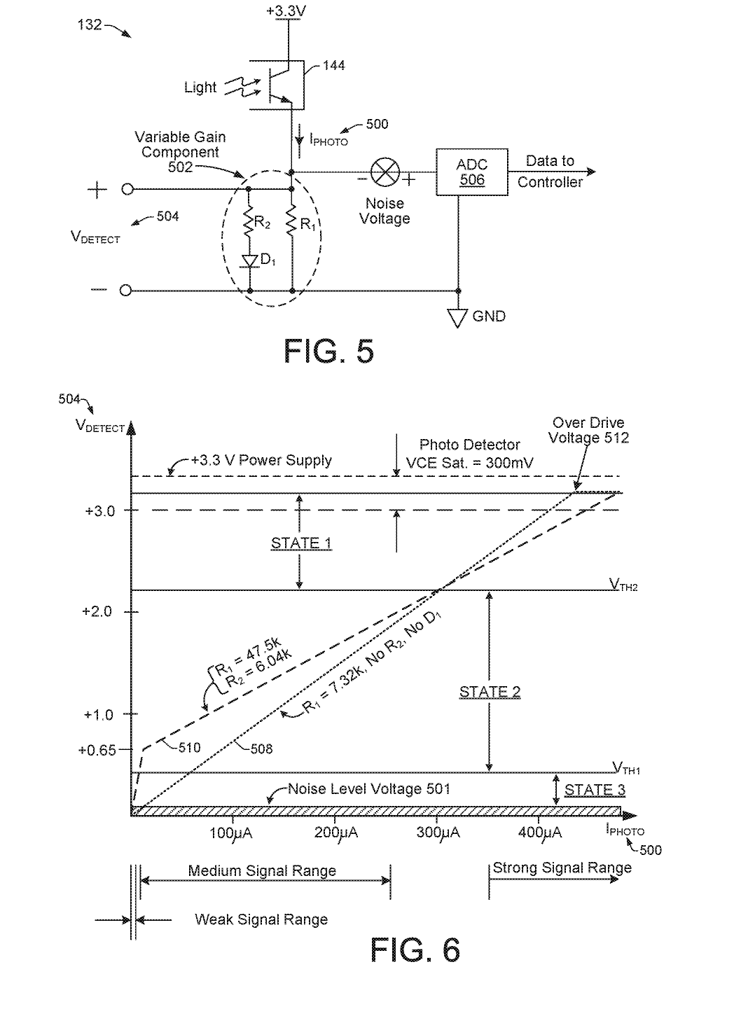

The sensor 134 includes a mirror 142 disposed on the media tray 202, as shown in FIGS. 1-4. The mirror 142 is located in general alignment with the LED 138 of the sensor 134 so that light 140 transmitted from the LED 138 is directed at the mirror 142. As shown in FIG. 4, when the media tray 202 is present or inserted into the media tray port 136 of printer 100 and the media tray is in a media empty condition (i.e., tray contains no media), light 140 transmitted from the LED 138 of the sensor 134 can reflect off of the mirror 142 and back to a photo-detector 144 on the sensor 134. Thus, in a “media empty condition” the photo-detector 144 receives reflected light from the LED 138. It is noted that in any condition, the photo-detector 144 may also receive an amount of ambient light. The photo-detector 144 can be implemented, for example, as a photo-transistor 144. The photo-detector 144 converts detected light into a current signal which can be used to determine conditions of the media and media tray, as discussed below with respect to FIGS. 5 and 6.

As noted above, FIG. 2 illustrates a “media present condition” in which there is cut-sheet media 200 present in the media tray 202, and the media tray is inserted into the media tray port 136 of printer 100. In this condition, although the mirror 142 on the media tray 202 is present and aligned with the LED 138 of sensor 134, light transmitted from the LED 138 does not reflect off the mirror 142 back to the photo-detector 144. Instead, light transmitted from the LED 138 reflects off of the cut-sheet media 200 that is present within the media tray 202 and back to the photo-detector 144. As noted above, in any condition, the photo-detector 144 may also receive an amount of ambient light. Again, the photo-detector 144 converts the light it receives into a current signal which can be used to determine conditions of the media and media tray, as discussed below with respect to FIGS. 5 and 6.

Referring again to FIG. 3, light 140 transmitted from LED 138 does not reflect off of the mirror 142 or the cut-sheet media 200 because the media tray is absent from the media tray port 136 of printer 100. However, as noted previously, an amount of ambient light may still be detected by photo-detector 144. Like the light reflected from the mirror 142 and media 200, the photo-detector 144 can convert the ambient light it detects into a current signal.

FIG. 5 shows an example of a sensor circuit 132 that can distinguish between weak, medium, and strong signals received from sensor 134 to enable determining between three different media conditions in a printer 100. FIG. 6 shows an example response of sensor circuit 132 to different current signal levels generated by sensor 134 in response to the three different media conditions. As shown in FIG. 5, the photo-detector 144 of sensor 134 generates a photo current (Iphoto) 500 upon detecting light, such as light 140 reflected from the mirror 142 or cut-sheet media 200, or ambient light, or a combination of ambient and reflected light. The photo current 500 induces a voltage V_{DETECT} 504 across a variable gain component 502. The variable gain component 502 comprises resistor R1 in parallel with a series combination of resistor R2 and diode D1. Diode D1 can be a diode such as a 1N914 or similar diode having a turn-on voltage of approximately 0.65 volts. The analog voltage V_{DETECT} 504 is converted by analog-to-digital convertor 506 into a digital voltage level that can be compared by compare module 123 executing on controller 104 with predetermined voltage threshold values 125, illustrated as VTH1 and VTH2 in FIG. 6. Sensor circuit 132 and comparisons by compare module 123 provide for three-state detection that can determine one of a media present condition, a media empty condition, and a media tray absent condition.

The expected signal levels shown in FIG. 6 below the X-axis (Iphoto) help to illustrate the challenge of three-state detection overcome by sensor circuit 132. The “STATE 1” area in the graph of FIG. 6 corresponds to strong photo current 500 signals resulting from direct reflection of the light beam 140 from mirror 142, which indicates a “media empty condition”. The “STATE 2” area of the graph corresponds to medium strength photo current 500 signals resulting from reflection of the light beam 140 off of different types of cut-sheet media 200 within media tray 202, which indicates a “media present condition.”The “STATE 3” area of the graph corresponds to weak photo current 500 signals where the media tray is not installed in the printer 100, which would indicate a “media tray absent” condition. The Noise Level Voltage 501 is shown at approximately 50 mV to illustrate how noise causes difficulty in discerning the difference between weak and medium signals (i.e., STATE 2 and STATE 3). Reflections from various types of paper (i.e., in the “media present condition”) are detected by photo-detector 144 to be between approximately 10 μA and 250 μA.

Referring to the sensor circuit 132 in FIG. 5 and the graph in FIG. 6, the ability to optimally detect the three different signal strength ranges (STATE 1, STATE 2, and STATE 3) depends on values selected for R1 and R2. If R1 and D1 were removed from circuit 132, the voltage 504 across R1 is proportional to the photo current 500 by Ohm's law. This voltage 504 is plotted along dotted line 508 which illustrates an example R1 value of 7.23 kohm where R1 and D1 are not part of the sensor circuit 132. That is, dotted line 508 represents a hypothetical sensor circuit 132 without the variable gain component 502. The dashed line 510 is a two-sloped curve of the voltage 504 generated with D1 and R2 in the circuit 132, and an increased value of R1. Diode D1 acts as a “diode switch.” The value of R1 is chosen to provide the assurance that the threshold voltage between medium signals and weak signals is as high as possible. This may help to eliminate detection issues that might otherwise arise by putting the VTH2 threshold at or around the Noise Level 501. The slope of the dashed voltage curve 510 illustrates variable gain, with a high gain (high slope) when photo currents 500 are low or below about 14 μA. The gain (slope) drops when diode D1 turns on at above 0.65 volts, which corresponds to approximately 14 μA. The gain (slope) drops because D1 effectively puts R1 in parallel with R2, which reduces the slope from a value of R1 to approximately (R1*R2)/(R1+R2). When R2 is chosen to be significantly smaller than R1, the slope is reduced enough that the VTH1 threshold is well below the Overdrive Voltage 512, which allows for a reliable detection between STATE 1 (strong signals) and STATE 2 (medium signals). The Overdrive Voltage 512 is near the positive voltage rail, +3.3V in this example, and the voltage 504 across R1 in parallel with D1 and R2 will not exceed or attain this voltage.

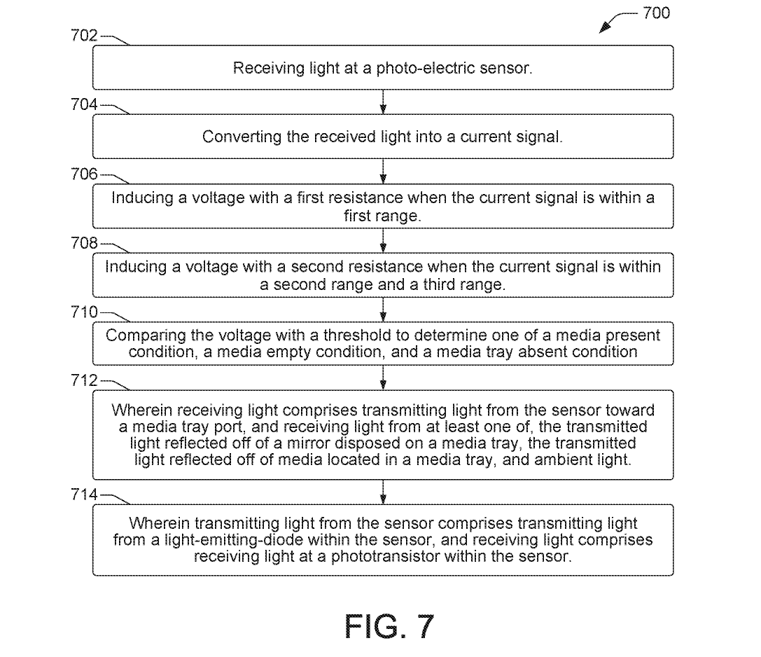

FIG. 7 shows a flow diagram that illustrates an example method 700 for sensing media and a media tray. Method 700 is associated with examples discussed above with regard to FIGS. 1-6, and details of the operations shown in method 700 can be found in the related discussion of such examples. In some examples, the operations of method 700 may be embodied as programming instructions stored on a non-transitory, machine-readable (e.g., computer/processor-readable) medium, such as memory 124 shown in FIG. 1. In some examples, implementing the operations of method 700 can be achieved by a processor, such as a processor 122 of FIG. 1, reading and executing the programming instructions stored in a memory 124. In some examples, implementing the operations of method 700 can be achieved using an ASIC 128 and/or other hardware components alone or in combination with programming instructions executable by processor 122.

Method 700 may include more than one implementation, and different implementations of method 700 may not employ every operation presented in the flow diagram of FIG. 7. Therefore, while the operations of method 700 are presented in a particular order within the flow diagram, the order of their presentation is not intended to be a limitation as to the order in which the operations may actually be implemented, or as to whether all of the operations may be implemented. For example, one implementation of method 700 might be achieved through the performance of a number of initial operations, without performing certain subsequent operations, while another implementation of method 700 might be achieved through the performance of all of the operations.

Referring now to the flow diagram of FIG. 7, an example method 700 of sensing media and a media tray begins at block 702, with receiving light at a photo-electric sensor. The light may be ambient light, and/or light reflected off of a mirror or cut-sheet media. At block 704, the method 700 continues with converting the received light into a current signal. When the current signal is within a first range, the method includes inducing a voltage with a first resistance, as shown at block 706. When the current signal is within a second and third range, the method 700 includes inducing a voltage with a second resistance, as shown at block 708. As shown at block 710, the voltage is compared with a threshold to determine one of a media present condition, a media empty condition, and a media tray absent condition.

In some examples, as shown at block 712, receiving light at a photo-electric sensor (block 702) can include transmitting light from the sensor toward a media tray port, and receiving light from at least one of, the transmitted light reflected off of a mirror disposed on a media tray, the transmitted light reflected off of media located in a media tray, and ambient light. As shown at block 714, transmitting light from the sensor can include transmitting light from a light-emitting-diode within the sensor, and receiving light comprises receiving light at a phototransistor within the sensor.

What is claimed is:

1. A device for sensing media and a media tray, comprising:
a sensor to transmit light toward a media tray port, and to generate current from light received at the sensor; and
a circuit to convert the current into a voltage signal to be compared with a threshold for determining one of a media present condition, a media empty condition, and a media tray absent condition.

2. A device as in claim 1, wherein the circuit comprises:
a variable gain component to induce voltage at a first gain when the current is in a first range, and to induce voltage at a second gain when the current is in a second range greater than the first range.

3. A device as in claim 2, wherein the variable gain component comprises:
a resistor, R1, coupled between the sensor and ground; and
a resistor, R2, and diode in series with one another and in parallel with R1, such that R2 is coupled between the sensor and the anode of the diode, and the cathode of the diode is coupled to ground.

4. A device as in claim 1, wherein the circuit further comprises:
an analog to digital convertor to convert the voltage signal into a digital voltage.

5. A device as in claim 4, further comprising:
threshold values stored in a memory; and
a threshold comparison module with instructions executable on a processor to compare the digital voltage to the threshold values and to determine one of the media present condition, the media empty condition, and the media tray absent condition.

6. A device as in claim 1, further comprising:
a mirror disposed on a media tray to reflect the transmitted light back to the sensor when the media tray is positioned within the media tray port.

7. A device as in claim 6, wherein the sensor comprises:
a light-emitting diode to transmit light; and
a photo-detector to detect light from at least one of, transmitted light reflected off the mirror, transmitted light reflected off of media located in the media tray, and ambient light.

8. A media and media tray sensing device, comprising:
a sensor disposed on a printer;
a mirror disposed on a media tray of the printer;
a light emitter in the sensor to transmit light;
a light detector in the sensor to receive light from at least one of, light reflected off the mirror, light reflected off of media in the media tray, and ambient light; and
a circuit to convert current from the light detector into a voltage for determining one of a media present condition, a media empty condition, and a media tray absent condition.

9. A sensing device as in claim 8, wherein the circuit comprises a variable gain component to generate a two-sloped voltage curve in response to current from the light detector.

10. A sensing device as in claim 9, wherein the variable gain component comprises a first resistor in parallel with a series combination of a diode and a second resistor.

11. A sensing device as in claim 10, wherein the variable gain component generates a first slope when the current is a weak current and a second slope when the current is a medium and strong current, the first slope being steeper than the second slope.

12. A sensing device as in claim 8, wherein the light detector comprises a photo-transistor that converts light into current.

13. A method for sensing media and a media tray, the method comprising:
receiving light at a photo-electric sensor;
converting the received light into a current signal;
inducing a voltage with a first resistance when the current signal is within a first range;
inducing a voltage with a second resistance when the current signal is within a second range and a third range; and
comparing the voltage with a threshold to determine one of a media present condition, a media empty condition, and a media tray absent condition.

14. A method as in claim 13, wherein receiving light comprises:
transmitting light from the sensor toward a media tray port;
receiving light from at least one of, the transmitted light reflected off of a mirror disposed on a media tray, the transmitted light reflected off of media located in a media tray, and ambient light.

15. A method as in claim 14, wherein:
transmitting light from the sensor comprises transmitting light from a light-emitting-diode within the sensor; and
receiving light comprises receiving light at a phototransistor within the sensor.
